(19) United States
(12) Patent Application Publication
(10) Pub. No.: US 2017/0127246 A1
(43) Pub. Date: May 4, 2017

(54) Method for Sharing Travelling Information, Vehicle Platform and Intelligent Traffic System

(71) Applicant: Leauto Intelligent Technology (BEIJING) Co. Ltd, Beijing (CN)

(72) Inventors: Yu Zou, Beijing (CN); Yong Xu, Beijing (CN); Wenrui Li, Beijing (CN); Kunsheng Chen, Beijing (CN); Dan Li, Beijing (CN); Wei Lin, Beijing (CN); Peng Liu, Beijing (CN)

(73) Assignee: Leauto Intelligent Technology (BEIJING) Co. Ltd, Beijing (CN)

(21) Appl. No.: 14/965,824

(22) Filed: Dec. 10, 2015

(30) Foreign Application Priority Data
Oct. 28, 2015 (CN) 201510712951.6

(51) Int. Cl. H04W 4/04; G01C 21/26

(52) U.S. Cl. CPC H04W 4/046; G01C 21/26

(57) ABSTRACT

The present disclosure provides a method for sharing travelling information, a vehicle platform and an intelligent traffic system. The vehicle platform comprises: a data acquisition module, used for acquiring road condition multimedia data of a first vehicle during running; a positioning module, used for acquiring positioning information of the first vehicle; an information broadcasting module, used for broadcasting the positioning information of the first vehicle to a second vehicle within a preset range; a sharing request receiving module, used for receiving a data sharing request sent by the second vehicle; and a data sending module, used for sending the road condition multimedia data to the second vehicle corresponding to the data sharing request on the basis of the data sharing request.

### FIELD OF TECHNOLOGY

The present disclosure relates to the technical field of traffic safety, and particularly relates to a vehicle platform for sharing travelling information, a method for sharing travelling information and an intelligent traffic system.

### BACKGROUND

With rapid development of the automobile industry and frequent use of automobiles, more and more vehicles run on roads, and accompanying safety accidents are continuously increased. In order to improve the accident avoiding capability of vehicles and reduce safety accidents, many vehicles have an active safety function nowadays. Wherein, the active safety indicates that the safety system measures of automobiles are freely controlled as much as possible, and the automobiles should be as stable as possible no matter in linear braking and acceleration or in left and right turning, are unlikely to deviate from the set travelling routes, and do not influence the visual field and the comfortableness of drivers.

As one of the active safety applications, forward looking systems of vehicles are increasingly widely used. In the prior art, a forward looking system of a vehicle mainly includes a travelling recorder and a travelling early warning system. Wherein, the travelling recorder is used for recording the road condition in front of the vehicle when the vehicle runs, so as to record and analyze an accident. The travelling early warning system is represented by Mobileye, and has driving auxiliary early warning functions of pedestrian detection, lane departure and the like.

However, the aforementioned forward looking system of the vehicle serves the vehicle on the basis of the visual angle of the vehicle, so the service object is too single; particularly under complex road conditions, e.g., the front shaded by large vehicles, invisible ramps, invisible tortuous roads and the like still belong to visual blind areas for drivers, so the forward looking system cannot be used for pre-judging some complex conditions.

### SUMMARY

The present disclosure provides a method for sharing travelling information, a vehicle platform and an intelligent traffic system, for solving the problems that the vehicle system in the prior art is too single in service object and cannot early warn complex road conditions in time.

The present disclosure provides a vehicle platform for sharing travelling information, including:

a data acquisition module, used for acquiring road condition multimedia data of a first vehicle during running;

a positioning module, used for acquiring positioning information of the first vehicle;

an information broadcasting module, used for broadcasting the positioning information of the first vehicle to a second vehicle within a preset range, wherein the second vehicle is connected with the first vehicle through a WAVE protocol;

a sharing request receiving module, used for receiving a data sharing request sent by the second vehicle, wherein the data sharing request is a request generated after the second vehicle determines a designated first vehicle on the basis of the positioning information of the first vehicle; and

a data sending module, used for sending the road condition multimedia data to the second vehicle corresponding to the data sharing request on the basis of the data sharing request.

The present disclosure further provides a vehicle platform for sharing travelling information, including:

a positioning information receiving module, used for receiving positioning information of a first vehicle, which is sent by the first vehicle;

a sharing request generating module, used for determining a designated first vehicle on the basis of the positioning information of the first vehicle, and then generating a data sharing request;

a sharing request sending module, used for sending the data sharing request to the designated first vehicle; and

a data receiving module, used for receiving road condition multimedia data sent by the designated first vehicle.

The present disclosure further provides an intelligent traffic system, including a first vehicle platform and a second vehicle platform which are positioned in different vehicles and connected with each other through a WAVE protocol, wherein,

the first vehicle platform includes:

a data acquisition module, used for acquiring road condition multimedia data of a first vehicle during running;

a positioning module, used for acquiring positioning information of the first vehicle;

an information broadcasting module, used for broadcasting the positioning information of the first vehicle to a second vehicle within a preset range;

a sharing request receiving module, used for receiving a data sharing request sent by the second vehicle; and

a data sending module, used for sending the road condition multimedia data to the second vehicle corresponding to the data sharing request on the basis of the data sharing request;

the second vehicle platform includes:

a positioning information receiving module, used for receiving positioning information of the first vehicle, which is sent by the first vehicle;

a sharing request generating module, used for determining a designated first vehicle on the basis of the positioning information of the first vehicle, and then generating a data sharing request;

a sharing request sending module, used for sending the data sharing request to the designated first vehicle; and

a data receiving module, used for receiving road condition multimedia data sent by the designated first vehicle.

The present disclosure further provides a method for sharing travelling information, including:

acquiring road condition multimedia data of a first vehicle during running;

acquiring positioning information of the first vehicle;

broadcasting the positioning information of the first vehicle to a second vehicle within a preset range, wherein the second vehicle is connected with the first vehicle through a WAVE protocol;

receiving a data sharing request sent by the second vehicle, wherein the data sharing request is a request generated after the second vehicle determines a designated first vehicle on the basis of the positioning information of the first vehicle; and

sending the road condition multimedia data to the second vehicle corresponding to the data sharing request on the basis of the data sharing request.

The present disclosure further provides a method for sharing travelling information, including:

receiving positioning information of a first vehicle, which is sent by the first vehicle;

determining a designated first vehicle on the basis of the positioning information of the first vehicle, and then generating a data sharing request;

sending the data sharing request to the designated first vehicle; and

receiving road condition multimedia data sent by the designated first vehicle.

According to the method for sharing travelling information, the vehicle platform and the intelligent traffic system provided by the present disclosure, the vehicle platform of the first vehicle acquires the positioning information of the first vehicle, then broadcasts the positioning information of the first vehicle to the second vehicle within the preset range, and sends the previously acquired road condition multimedia data to the second vehicle sending the data sharing request when receiving the data sharing request sent by the second vehicle, to realize travelling information sharing, so that the road condition multimedia data acquired by a vehicle not only serves the vehicle itself, but also serves other vehicles, and the service objects of the travelling information are enriched. Moreover, for a vehicle receiving the shared data, the front obstacle can be early warned in advance, so that the traffic accident avoiding capability of the vehicle is strengthened and the traffic early warning efficiency is improved.

### BRIEF DESCRIPTION OF THE DRAWINGS

In order to describe the technical solutions in the embodiments of the present disclosure or in the prior art more clearly, a simple introduction on the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a structural block diagram of a vehicle platform for sharing travelling information of an embodiment of the present disclosure;

FIG. 2 is a structural block diagram of a vehicle platform for sharing travelling information of another embodiment of the present disclosure;

FIG. 3 is a structural block diagram of an intelligent traffic system of an embodiment of the present disclosure;

FIG. 4 is a step flow diagram of a method for sharing travelling information of an embodiment of the present disclosure;

FIG. 5 is a step flow diagram of a method for sharing travelling information of another embodiment of the present disclosure.

### DESCRIPTION OF THE EMBODIMENTS

To make the objectives, technical solutions and advantages of the embodiments of the present disclosure clearer, a clear and complete description of the technical solutions in the present disclosure will be given below, in combination with the accompanying drawings in the embodiments of the present disclosure. Apparently, the embodiments described below are a part, but not all, of the embodiments of the present disclosure. All of the other embodiments, obtained by those of ordinary skill in the art based on the embodiments of the present disclosure without any inventive efforts, fall into the protection scope of the present disclosure.

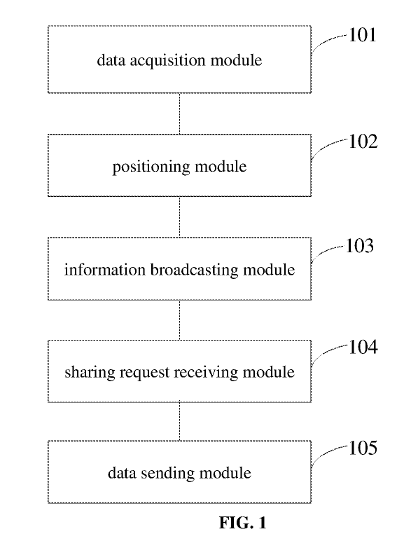

Refer to FIG. 1, which shows a structural block diagram of a vehicle platform for sharing travelling information of an embodiment of the present disclosure.

The vehicle platform in the embodiments of the present disclosure may support V2X communication, V2X (Vehicle-to-X) indicates the communication between a vehicle and peripheral equipment, and X includes a vehicle, a roadside unit, a service station and the like. At present, the V2X wireless communication technology follows the WAVE (Wireless Access in Vehicular Environment) standard, wherein the WAVE standard is set by IEEE (Institute of Electrical and Electronic Engineers) and includes an IEEE 1609 protocol family and an 802.11p protocol, and a higher communication rate and a larger transmission range can be achieved by adopting an 802.11-based protocol architecture. By adopting the WAVE standard, identification and two-way communication of moving objects moving at a high speed in a specific small area (generally dozens of meters) can be realized, e.g., “vehicle-road” and “vehicle-vehicle” two-way communication of vehicles, and images, sound and data information can be transmitted to organically connect vehicles with roads.

The physical layer of V2X follows an IEEE802.11P protocol, the transmission frequency is 5.9 HZ band, the transmission distance is 300 m-1000 m, and the transmission rate is 3 M-27 Mbps; in a data link layer and the above IEEE1609 protocol family, a self-organizing network is formed between communication nodes, and unicast and broadcast communication can be implemented in the network; and in an application layer, state information of application nodes of vehicles and the like are sent by adopting an SAE J2735 short message set, and the state information may include speed, longitude and latitude, etc. The V2X is mainly used in the fields of intelligent traffic and driving active safety, to reduce traffic accidents and improve the traffic efficiency.

As shown in FIG. 1, the vehicle platform in the embodiment of the present disclosure may include a data acquisition module 101, a positioning module 102, an information broadcasting module 103, a sharing request receiving module 104 and a data sending module 105.

The data acquisition module 101 is used for acquiring road condition multimedia data of a first vehicle during running.

In the embodiment of the present disclosure, the vehicle platform is installed in both the first vehicle and a second vehicle, the vehicle platform of the first vehicle may be connected with the vehicle platform of the second vehicle through a WAVE transmission protocol, physical layers of the vehicles communicate with each other through IEEE802.11P, and a network is organized between the vehicles by using a self-organizing network communication protocol IEEE1609.

The vehicle platform of the first vehicle may acquire the road condition multimedia data of the first vehicle during running through the data acquisition module 101. As an example, the road condition multimedia data may include road condition video data, e.g., video data of the road condition in the front of the current road, or video data in other directions of the current road, etc.

In specific implementation, the data acquisition module 101 may acquire the road condition multimedia data through a camera. In an implementation mode, the data acquisition module 101 may be a travelling recorder, i.e., an instrument for recording relevant data of a vehicle such as images and sound during running, and after the travelling recorder is installed, video images and sound in the whole running process of the vehicle can be recorded, so that proofs can be provided for traffic accidents.

After the data acquisition module 101 acquires the road condition multimedia data, the road condition multimedia data can be compressed and coded according to an H.264 format, so that the transmission of data stream does not exceed valid transmission bandwidth 3 Mbps of V2X; and the compressed road condition multimedia data can be stored in a storage hard disk in real time for later use.

The positioning module 102 is used for acquiring positioning information of the first vehicle.

The vehicle platform of the first vehicle may further include the positioning module 102 used for acquiring the positioning information of the first vehicle. As a preferred example of the embodiment of the present disclosure, the positioning information of the first vehicle at least may include longitude and latitude information, running state information and the like of the vehicle, wherein the running state information of the vehicle may include course information, running speed information, brake state and the like of the vehicle.

In specific implementation, the positioning module 102 may acquire the longitude and latitude information of the first vehicle by adopting the following positioning system: GPS (Global Positioning System), GNSS (Global Navigation Satellite System), BDS (BeiDou Navigation Satellite System), GLONASS (Glonass Navigation Satellite System), etc.

Meanwhile, the positioning module 102 may further acquire the running state information of the vehicle from a vehicular OBD (On Board Diagnostics) interface through a CAN (Controller Area Network) bus.

The information broadcasting module 103 is used for broadcasting the positioning information of the first vehicle to a second vehicle within a preset range.

The positioning module 102 acquires the positioning information of the first vehicle and then transmits the positioning information of the first vehicle to the information broadcasting module 103, and the information broadcasting module 103 may package the positioning information of the first vehicle as a DSRC (Dedicated Short Range Communications) basic short message set and broadcast the DSRC basic short message set to the surrounding vehicle, wherein the surrounding vehicle may be the second vehicle within the preset range.

The sharing request receiving module 104 is used for receiving a data sharing request sent by the second vehicle;

wherein, the data sharing request is a request generated after the second vehicle determines a designated first vehicle on the basis of the positioning information of the first vehicle.

The second vehicle within the preset range receives a WAVE message (i.e., the DSRC basic short message set including the positioning information of the first vehicle) sent by the first vehicle, and then analyzes the WAVE message, to obtain the positioning information of the first vehicle and the communication address of the first vehicle.

Meanwhile, the second vehicle may also acquire self positioning information (i.e., positioning information of the second vehicle) and analyze the position information of the first vehicle relative to the second vehicle by utilizing relative position information of the vehicles, and the position information of the first vehicle relative to the second vehicle may include distance and azimuth information and the like of the first vehicle relative to the second vehicle.

In specific implementation, the distance and azimuth information of the first vehicle relative to the second vehicle may be calculated in the following mode:

it is supposed that the longitude and latitude information of the second vehicle (point A) is (Aj, Aw), and the longitude and latitude information of the first vehicle (point B) is (Bj, Bw);

the trihedral angle cosine formula of the points A and B is as follows (the northern latitude is positive, and the southern latitude is negative; the east longitude is positive, and the west longitude is negative):

cos(c)=cos(90−Bw)×cos(90−Aw)+sin(90−Bw)×sin(90−Aw)×cos(Bj−Aj)

the degree of c in the above formula is solved with an arc-cosine function:

c=arccos(cos(90−Bw)×cos(90−Aw)+sin(90−Bw)×sin(90−Aw)×cos(Bj−Aj))

then the degree is converted into radian:

$$c ( radian ) = \frac{c}{180} \times π$$

the distance L between the points A and B is calculated according to the radian:

L=R×c(radian)

wherein, R is the mean radius of the earth.

The sine value of c is solved according to the cosine value thereof:

[symbol]

(c)=\sqrt{1−cos²(c)}.

after the sine value is obtained, according to the spherical sine formula:

$$\frac{a}{sin ( A )} = \frac{b}{sin ( B )} = \frac{c}{sin ( C )} ,$$

the following equation is obtained:

$$sin ( A ) = sin ( \frac{sin ( 90 - Bw ) \times sin ( Bj - Aj )}{sin ( c )} )$$

the azimuth information (azimuth) of the first vehicle relative to the second vehicle is obtained with an inverse sine function:

$$A = arcsin ( \frac{sin ( 90 - Bw ) \times sin ( Bj - Aj )}{sin ( c )} ) .$$

It should be noted that, the above mode of calculating the distance and the azimuth information is merely an example of the embodiment of the present disclosure, those skilled in the art could adopt other modes to calculate the distance and the azimuth information of the first vehicle and the second vehicle, and the embodiment of the present disclosure is not limited thereto.

After the second vehicle acquires the position information of the first vehicle relative to the second vehicle, the position information of the first vehicle relative to the second vehicle may be displayed in a display interface of the second vehicle. When there are multiple first vehicles, the position information of the multiple first vehicles may be displayed in the display interface of the second vehicle.

In the presence of multiple first vehicles, a user may designate one of the first vehicles as a designated first vehicle for receiving the request in the display interface of the vehicle platform of the second vehicle. By default, the designated first vehicle may be the one closest to the second vehicle, or the user manually selects one of the multiple first vehicles as the designated first vehicle for receiving the request. In practice, the designated first vehicle may be preferably a vehicle in front of the second vehicle.

In specific implementation, the user may manually select the designated first vehicle for receiving the request in the following modes: when the display interface is a touch screen interface, the user manually clicks a certain first vehicle in the touch screen as the designated first vehicle; and when the display interface is a non-touch screen interface, the user selects a certain first vehicle as the designated first vehicle through the keyboard.

When the driver of the second vehicle discovers a visual obstacle such as a truck, an abrupt slope, a tortuous road and the like ahead, the driver may click a sharing request key in the display interface, to trigger the vehicle platform of the second vehicle to generate a data sharing request; and after the data sharing request is generated, the vehicle platform of the second vehicle may acquire the communication address pre-stored in the designated first vehicle, and sends the data sharing request to the communication address of the designated first vehicle.

The vehicle platform of the designated first vehicle may receive the data sharing request through the sharing request receiving module 104.

The data sending module 105 is used for sending the road condition multimedia data to the second vehicle corresponding to the data sharing request on the basis of the data sharing request.

The vehicle platform of the designated first vehicle receives the data sharing request sent by the second vehicle through the sharing request receiving module 104, and then transmits the data sharing request to the data sending module 105; and the data sending module 105 sends the compressed road condition multimedia data to the second vehicle of the data sharing request through V2X in real time according to the data sharing request, thus realizing real-time sharing of the road condition multimedia data.

In the embodiment of the present disclosure, the second vehicle sending the data sharing request may show the road condition multimedia data to the driver after receiving the road condition multimedia data shared with the first vehicle, the driver may execute a stop operation after learning the road condition ahead, e.g., clicking a stop button in the display interface, the second vehicle may generate a stop request after detecting the stop operation and send the stop request to the communication address of the first vehicle, the first vehicle may receive the stop request through a stop request receiving module (not shown in the figure) and transmit the stop request to a stop module (not shown in the figure), the stop module stops sending the road condition multimedia data to the second vehicle on the basis of the stop request, and after the second vehicle stops receiving the road condition multimedia data, the current display interface of the second vehicle is restored to a travelling record display mode.

In the embodiment of the present disclosure, the vehicle platform of the first vehicle broadcasts the positioning information of the first vehicle to the second vehicle within the preset range after acquiring the positioning information of the first vehicle, and sends the previously acquired road condition multimedia data to the second vehicle sending the data sharing request when receiving the data sharing request sent by the second vehicle, to realize sharing of travelling information, so that the road condition multimedia data acquired by a vehicle not only serves the vehicle itself, but also serves other vehicles, and the service objects of the travelling information are enriched. Moreover, for a vehicle receiving the shared data, the front obstacle can be early warned in advance, so that the traffic accident avoiding capability of the vehicle is strengthened and the traffic efficiency is improved.

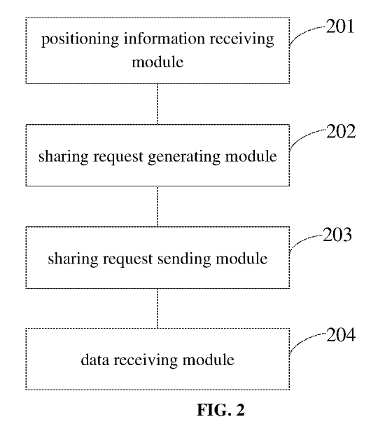

See FIG. 2, and it shows a structural block diagram of a vehicle platform for sharing travelling information of another embodiment of the present disclosure. The vehicle platform may include a positioning information receiving module 201, a sharing request generating module 202, a sharing request sending module 203 and a data receiving module 204.

The positioning information receiving module 201 is used for receiving positioning information of a first vehicle, which is sent by the first vehicle.

As a preferred example of the embodiment of the present disclosure, the positioning information of the first vehicle at least may include longitude and latitude information, running state information and the like of the vehicle, wherein the running state information of the vehicle may include course information, running speed information, brake state and the like of the vehicle.

The sharing request generating module 202 is used for determining a designated first vehicle on the basis of the positioning information of the first vehicle, and then generating a data sharing request.

The sharing request sending module 203 is used for sending the data sharing request to the designated first vehicle.

The data receiving module 204 is used for receiving road condition multimedia data sent by the designated first vehicle.

In a preferred embodiment of the embodiments of the present disclosure, the vehicle platform may further include the following module:

a stop request sending module, used for, when detecting a stop operation executed by a user, generating a stop request, and sending the stop request to the designated first vehicle.

The designated first vehicle is used for stopping sending the road condition multimedia data to the second vehicle on the basis of the stop request, wherein the second vehicle is connected with the first vehicle through a WAVE protocol.

In a preferred embodiment of the embodiments of the present disclosure, the vehicle platform may further include a positioning module, a calculation module, a display module and a vehicle selection module.

The positioning module is used for acquiring positioning information of the second vehicle.

As a preferred example of the embodiment of the present disclosure, the positioning information of the second vehicle at least may include longitude and latitude information, running state information and the like of the vehicle, wherein the running state information of the vehicle may include course information, running speed information, brake state and the like of the vehicle.

The calculation module is used for calculating the position information of the first vehicle relative to the second vehicle on the basis of the positioning information of the second vehicle and the positioning information of the first vehicle.

The display module is used for displaying the position information in a display interface of the second vehicle.

The vehicle selection module is used for determining a designated first vehicle for receiving the data sharing request on the basis of the position information of the first vehicle relative to the second vehicle.

In the embodiment of the present disclosure, after receiving the positioning information of the first vehicle, the vehicle platform of the second vehicle determines the designated first vehicle according to the positioning information of the first vehicle, generates the data sharing request and sends the generated data sharing request to the designated first vehicle, and the designated first vehicle shares the road condition multimedia data to the second vehicle on the basis of the data sharing request, to realize sharing of travelling information, so that the road condition multimedia data acquired by a vehicle not only serves the vehicle itself, but also serves other vehicles, and the service objects of the travelling information are enriched. Moreover, for a vehicle receiving the shared data, the front obstacle can be early warned in advance, so that the traffic accident avoiding capability of the vehicle is strengthened and the traffic efficiency is improved.

With respect to the embodiment of FIG. 2, because it is substantially similar to the embodiment of FIG. 1, it is described relatively simply; and for the similar part, reference may be made to part of the description of the embodiment of FIG. 1.

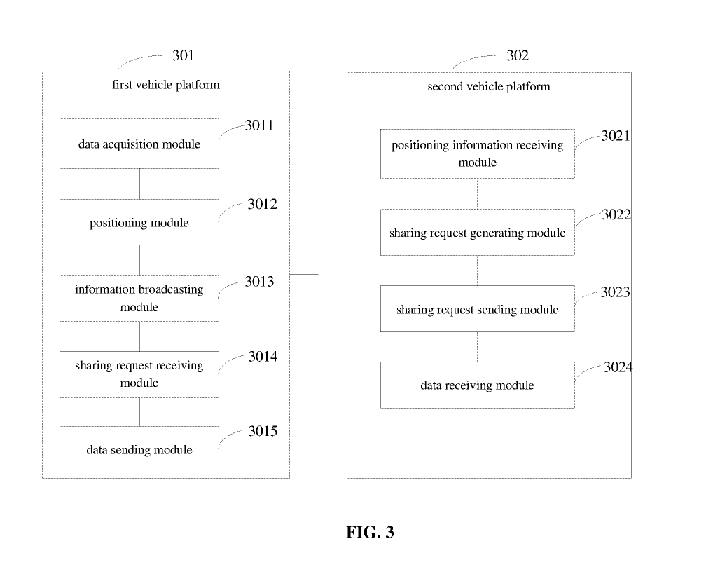

Refer to FIG. 3, which shows a structural block diagram of an intelligent traffic system of an embodiment of the present disclosure. The intelligent traffic system may include a first vehicle platform 301 and a second vehicle platform 302 which are positioned in different vehicles and connected with each other through a WAVE protocol, wherein,

the first vehicle platform 301 includes:

a data acquisition module 3011, used for acquiring road condition multimedia data of a first vehicle during running;

a positioning module 3012, used for acquiring positioning information of the first vehicle;

an information broadcasting module 3013, used for broadcasting the positioning information of the first vehicle to a second vehicle within a preset range;

a sharing request receiving module 3014, used for receiving a data sharing request sent by the second vehicle; and

a data sending module 3015, used for sending the road condition multimedia data to the second vehicle corresponding to the data sharing request on the basis of the data sharing request;

in a preferred embodiment of the embodiments of the present disclosure, the first vehicle platform 301 further includes:

a stop request receiving module, used for receiving a stop request sent by the second vehicle corresponding to the data sharing request; and

a stop module, used for stopping sending the road condition multimedia data to the second vehicle corresponding to the data sharing request on the basis of the stop request.

In a preferred embodiment of the embodiments of the present disclosure, the positioning information of the first vehicle at least includes longitude and latitude information, course information and running speed information of the vehicle.

The second vehicle platform 302 includes:

a positioning information receiving module 3021, used for receiving positioning information of a first vehicle, which is sent by the first vehicle;

a sharing request generating module 3022, used for determining a designated first vehicle on the basis of the positioning information of the first vehicle, and then generating a data sharing request;

a sharing request sending module 3023, used for sending the data sharing request to the designated first vehicle; and

a data receiving module 3024, used for receiving road condition multimedia data sent by the designated first vehicle.

In a preferred embodiment of the embodiments of the present disclosure, the second vehicle platform 302 further includes:

a stop request sending module, used for, when detecting a stop operation executed by a user, generating a stop request, and sending the stop request to the designated first vehicle. The designated first vehicle is used for stopping sending the road condition multimedia data to the second vehicle on the basis of the stop request, wherein the second vehicle is connected with the first vehicle through a WAVE protocol.

In a preferred embodiment of the embodiments of the present disclosure, the second vehicle platform 302 further includes:

a positioning module, used for acquiring positioning information of the second vehicle;

a calculation module, used for calculating the position information of the first vehicle relative to the second vehicle on the basis of the positioning information of the second vehicle and the positioning information of the first vehicle;

a display module, used for displaying the position information in a display interface of the second vehicle; and

a vehicle selection module, used for determining a designated first vehicle for receiving the data sharing request on the basis of the position information of the first vehicle relative to the second vehicle.

With respect to the system embodiment of FIG. 3, because it is substantially similar to the embodiments of FIG. 1 and FIG. 2, it is described relatively simply; and for the similar part, reference may be made to part of the descriptions of the embodiments of FIG. 1 and FIG. 2.

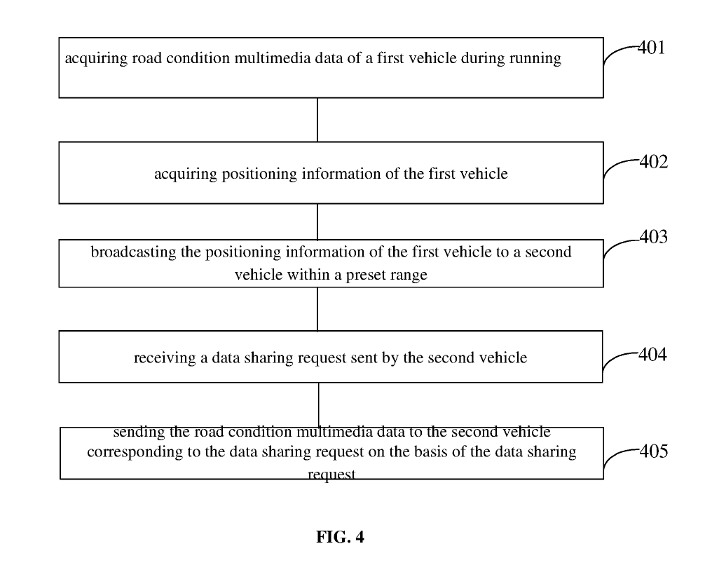

Refer to FIG. 4, which shows a step flow diagram of a method for sharing travelling information of an embodiment of the present disclosure. The method may include the following steps:

401, acquiring road condition multimedia data of a first vehicle during running;

402, acquiring positioning information of the first vehicle;

403, broadcasting the positioning information of the first vehicle to a second vehicle within a preset range, wherein the second vehicle is connected with the first vehicle through a WAVE protocol;

404, receiving a data sharing request sent by the second vehicle, wherein the data sharing request is a request generated after the second vehicle determines a designated first vehicle on the basis of the positioning information of the first vehicle;

405, sending the road condition multimedia data to the second vehicle corresponding to the data sharing request on the basis of the data sharing request.

In a preferred embodiment of the embodiments of the present disclosure, the method further includes the following steps:

receiving a stop request sent by the second vehicle corresponding to the data sharing request; and stopping sending the road condition multimedia data to the second vehicle corresponding to the data sharing request on the basis of the stop request.

In a preferred embodiment of the embodiments of the present disclosure, the positioning information of the first vehicle at least includes longitude and latitude information, course information and running speed information of the vehicle.

With respect to the method embodiment of FIG. 4, because it is substantially similar to the embodiment of FIG. 1, it is described relatively simply; and for the similar part, reference may be made to part of the description of the embodiment of FIG. 1.

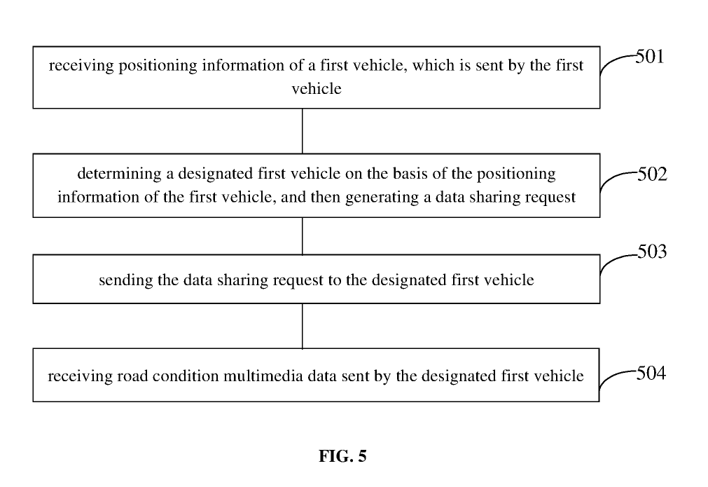

See FIG. 5, which shows a step flow diagram of a method for sharing travelling information of another embodiment of the present disclosure. The method may include the following steps:

501, receiving positioning information of a first vehicle, which is sent by the first vehicle;

502, determining a designated first vehicle on the basis of the positioning information of the first vehicle, and then generating a data sharing request;

503, sending the data sharing request to the designated first vehicle; and

504, receiving road condition multimedia data sent by the designated first vehicle.

In a preferred embodiment of the embodiments of the present disclosure, the method further includes the following steps:

when detecting a stop operation executed by a user, generating a stop request, and sending the stop request to the designated first vehicle. The designated first vehicle is used for stopping sending the road condition multimedia data to the second vehicle on the basis of the stop request, wherein the second vehicle is connected with the first vehicle through a WAVE protocol.

In a preferred embodiment of the embodiments of the present disclosure, the method further includes the following steps:

acquiring positioning information of the second vehicle;

calculating the position information of the first vehicle relative to the second vehicle on the basis of the positioning information of the second vehicle and the positioning information of the first vehicle;

displaying the position information in a display interface of the second vehicle;

determining a designated first vehicle for receiving the data sharing request on the basis of the position information of the first vehicle relative to the second vehicle.

With respect to the method embodiment of FIG. 5, because it is substantially similar to the embodiment of FIG. 2, it is described relatively simply; and for the similar part, reference may be made to part of the description of the embodiment of FIG. 2.

In a preferred embodiment of the embodiments of the present disclosure, a vehicle platform for sharing travelling information, comprising: a processor; and a memory for storing instructions executable by the processor; wherein the processor is configured to: acquire road condition multimedia data of a first vehicle during running; acquire positioning information of the first vehicle; broadcast the positioning information of the first vehicle to a second vehicle within a preset range, wherein the second vehicle is connected with the first vehicle through a WAVE protocol; receive a data sharing request sent by the second vehicle, wherein the data sharing request is a request generated after the second vehicle determines a designated first vehicle on the basis of the positioning information of the first vehicle; and send the road condition multimedia data to the second vehicle corresponding to the data sharing request on the basis of the data sharing request.

The processor is further configured to: receive a stop request sent by the second vehicle corresponding to the data sharing request; and send the road condition multimedia data to the second vehicle corresponding to the data sharing request on the basis of the stop request.

Wherein the positioning information of the first vehicle at least comprises longitude and latitude information, course information and running speed information of the vehicle.

In a preferred embodiment of the embodiments of the present disclosure, an intelligent traffic system, comprising a first vehicle platform and a second vehicle platform which are positioned in different vehicles and connected with each other through a WAVE protocol, wherein, the first vehicle platform comprises: a processor; and a memory for storing instructions executable by the processor; wherein the processor is configured to: acquire road condition multimedia data of a first vehicle during running; acquire positioning information of the first vehicle; broadcast the positioning information of the first vehicle to a second vehicle within a preset range; receive a data sharing request sent by the second vehicle; and send the road condition multimedia data to the second vehicle corresponding to the data sharing request on the basis of the data sharing request; the second vehicle platform comprises: a processor; and a memory for storing instructions executable by the processor; wherein the processor is configured to receive positioning information of the first vehicle, which is sent by the first vehicle; determine a designated first vehicle on the basis of the positioning information of the first vehicle, and then generating a data sharing request; send the data sharing request to the designated first vehicle; and receive road condition multimedia data sent by the designated first vehicle.

The embodiments of the vehicle platform, the intelligent traffic system and the like described above are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part or all of the modules according to actual needs. Those of ordinary skill in the art could understand and implement the embodiments without any creative effort.

Through the descriptions of the above embodiments, those skilled in the art could clearly learn that each embodiment may be realized by means of software and a necessary general hardware platform, and of course, may be realized by hardware. Based on such a understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling computer equipment (which may be a personal computer, a server, or network equipment and the like) to execute each embodiment or the method at some part of each embodiment.

Finally, it should be noted that, the above embodiments are merely used for illustrating the technical solutions of the present disclosure, rather than limiting the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent alterations may be made to part of the technical characteristics thereof; and these modifications or alterations do not make the nature of the corresponding technical solutions depart from the spirit and scope of the technical solutions of the respective embodiments of the present disclosure.

1. A vehicle platform for sharing travelling information, comprising:
a processor; and
a memory for storing instructions executable by the processor;
wherein the processor is configured to:
acquire road condition multimedia data of a first vehicle during running;
acquire positioning information of the first vehicle;
broadcast the positioning information of the first vehicle to a second vehicle within a preset range, wherein the second vehicle is connected with the first vehicle through a WAVE protocol;
receive a data sharing request sent by the second vehicle, wherein the data sharing request is a request generated after the second vehicle determines a designated first vehicle on the basis of the positioning information of the first vehicle; and
send the road condition multimedia data to the second vehicle corresponding to the data sharing request on the basis of the data sharing request.

2. The vehicle platform of claim 1, the processor is further configured to:
receive a stop request sent by the second vehicle corresponding to the data sharing request; and
send the road condition multimedia data to the second vehicle corresponding to the data sharing request on the basis of the stop request.

3. The vehicle platform of claim 1, wherein the positioning information of the first vehicle at least comprises longitude and latitude information, course information and running speed information of the vehicle.

4. An intelligent traffic system, comprising a first vehicle platform and a second vehicle platform which are positioned in different vehicles and connected with each other through a WAVE protocol, wherein,
the first vehicle platform comprises:
a processor; and
a memory for storing instructions executable by the processor;
wherein the processor is configured to:
acquire road condition multimedia data of a first vehicle during running;
acquire positioning information of the first vehicle;
broadcast the positioning information of the first vehicle to a second vehicle within a preset range;
receive a data sharing request sent by the second vehicle; and
send the road condition multimedia data to the second vehicle corresponding to the data sharing request on the basis of the data sharing request;
the second vehicle platform comprises:
a processor; and
a memory for storing instructions executable by the processor;
wherein the processor is configured to:
receive positioning information of the first vehicle, which is sent by the first vehicle;
determine a designated first vehicle on the basis of the positioning information of the first vehicle, and then generating a data sharing request;
send the data sharing request to the designated first vehicle; and
receive road condition multimedia data sent by the designated first vehicle.

5. A method for sharing travelling information, comprising:
acquiring road condition multimedia data of a first vehicle during running;
acquiring positioning information of the first vehicle;
broadcasting the positioning information of the first vehicle to a second vehicle within a preset range, wherein the second vehicle is connected with the first vehicle through a WAVE protocol;
receiving a data sharing request sent by the second vehicle, wherein the data sharing request is a request generated after the second vehicle determines a designated first vehicle on the basis of the positioning information of the first vehicle; and
sending the road condition multimedia data to the second vehicle corresponding to the data sharing request on the basis of the data sharing request.

6. The vehicle platform of claim 2, wherein the positioning information of the first vehicle at least comprises longitude and latitude information, course information and running speed information of the vehicle.
